(19) United States
(12) Patent Application Publication
(10) Pub. No.: US 2005/0089653 A1
(43) Pub. Date: Apr. 28, 2005

(54) Bitumen-based adhesive in lignocellulosic product

(76) Inventors: Haggai Shoshany, Kfar Tavor (IL); Amnon Shoshany, Tel Aviv (IL)

Correspondence Address: DEKEL PATENT LTD., DAVID KLEIN, BEIT HAROF'IM, 18 MENUHA VENAHALA STREET, ROOM 27, REHOVOT, 76209, IL

(21) Appl. No.: 10/689,587

(22) Filed: Oct. 22, 2003

(51) Int. Cl. B32B 1/08

(52) U.S. Cl. 428/34.1; 156/190; 156/195; 156/188; 156/187; 156/210; 156/292; 156/337; 428/182

(57) ABSTRACT

A method including winding a first layer of a material about a mandrel, and bonding a second layer of a material to the first layer with a bitumen-based adhesive, wherein an active component of the bitumen-based adhesive is bitumen, and wherein at least one of the first and second layers comprises a lignocellulosic material. Another embodiment includes forming corrugated board by bonding a corrugated sheet to at least one outer sheet with a bitumen-based adhesive, wherein an active component of said bitumen-based adhesive is bitumen, and wherein at least one of said corrugated sheet and said outer sheet comprises a lignocellulosic material. Articles made according to the methods are also described.

### FIELD OF THE INVENTION

The present invention relates generally to products manufactured by bonding sheets or layers with an adhesive, such as spiral-wound or convolute-wound tubes or corrugated board, and particularly to bonding such sheets or layers with a bitumen-based adhesive.

### BACKGROUND OF THE INVENTION

There are many products that are constructed from strips, sheets or layers of paper, chipboard and the like, bonded together with an adhesive. Examples of such products are spiral-wound or convolute-wound tubes, or corrugated board (e.g., paper, carton or cardboard and the like).

Spiral-wound tubes include, without limitation, the inner tube around which toilet paper rolls or paper towels are wound, and tubes used to hold cookie dough, biscuits, grease, caulk, frozen juice products, etc. Such tubes typically comprise layers of paper and/or different kinds of materials such as but not limited to, metallic foil, plastic, etc., bonded together with an adhesive, such as but not limited to, polyvinyl acetate (PVA), polyvinyl alcohol (PVOH), dextrin, sodium silicate and the like. Hot-melt adhesives or room-temperature adhesives may be used. Convolute-wound tubes are similar to spiral-wound tubes, except that in convolute-wound tubes the layers are wound upon each other without spiraling.

Corrugated board may be constructed of a corrugated or honeycomb sheet and the like sandwiched between two or more outer sheets. The corrugated sheet is generally bonded to the other sheets with the same type of adhesive as that used to make convolute-wound or spiral-wound tubes.

### SUMMARY OF THE INVENTION

The present invention seeks to provide a lignocellulosic product and method of manufacture therefor, by bonding sheets or layers with a bitumen-based adhesive. The use of the bitumen-based adhesive instead of the non-bitumen-based adhesives of the prior art may provide significant cost savings, since bitumen-based adhesives are generally less expensive. The lignocellulosic product made in accordance with the present invention may include spiral-wound or convolute-wound tubes and/or corrugated board, as is described more in detail hereinbelow.

“Lignocellulosic” material refers to any plant material emanating from the photosynthetic phenomenon. This includes, but is not limited to, paper, carton, chipboard, cardboard, manila, linen, cotton cloth, woven hessian, and the like. A sheet of a lignocellulosic material may be, for example, a sheet of paper, a sheet of a composite lignocellulosic material, e.g., chipboard or fiberboard, or a sheet of timber, e.g., a peeled, sliced or sawn thin section of timber.

### BRIEF DESCRIPTION OF DRAWINGS

The present invention will be further understood and appreciated from the following detailed description taken in conjunction with the drawing in which:

FIG. 1 is a simplified schematic, not-to-scale illustration of a method for making a lignocellulosic product, in accordance with an embodiment of the invention;

FIG. 2 is a simplified side-view illustration of rolls of layer material used in FIG. 1, showing an adhesive disposed between the layers so that they are bonded together when wrapped around a mandrel shown in FIG. 1;

FIG. 3 is a simplified pictorial illustration of a spiral-wound tube, constructed in accordance with an embodiment of the invention;

FIG. 4 is a simplified pictorial illustration of a convolute-wound tube, constructed in accordance with an embodiment of the invention; and

FIG. 5 is a simplified pictorial illustration of a corrugated board, constructed in accordance with an embodiment of the invention.

### DETAILED DESCRIPTION OF THE INVENTION

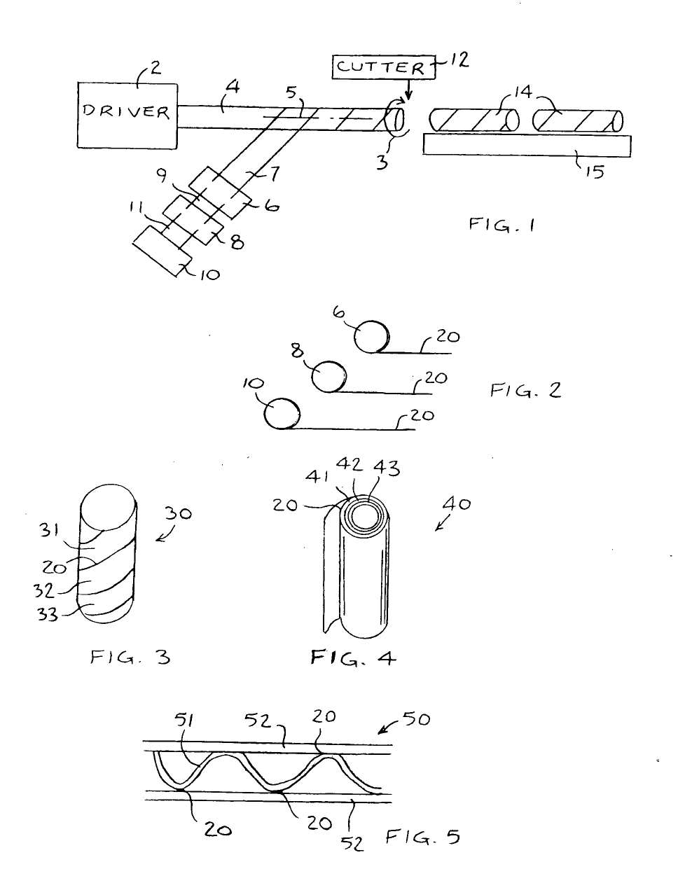

Reference is now made to FIG. 1, which illustrates a method for making a lignocellulosic product, in accordance with an embodiment of the invention. In FIG. 1, the lignocellulosic product is a spiral-wound tube, but the invention is not limited to this kind of tube, as is described further below.

In FIG. 1, a driver 2 may rotate lignocellulosic strips or sheets or the like around a mandrel 4 in the direction of an arrow 3 about a longitudinal axis 5. A roll 6 of outer layer material 7 in sheet or web form may be fed to mandrel 4 and may be wrapped spirally (helically) thereabout as the strips rotate in the direction 3. Any number of layers may be used. For example, beside, below or behind the roll 6, a roll 8 of a middle layer material 9 may be fed to mandrel 4 underneath the outer sheet 7. A roll 10 of an inner layer web or sheet 11 may be fed to mandrel 4 and wrapped spirally (helically) thereabout beneath the middle web or sheet. This produces a continuous three-layer spiral-wound hollow tube in hollow cylindrical form, which moves to the right in the sense of FIG. 1 as a new continuous tube is formed. (Again, the invention is not limited to three layers, and may comprise any number of layers.)

The layer material may be lignocellulosic, and may comprise, without limitation, paper, Kraft paper, chipboard, cardboard, manila and other suitable substrates and materials. Other non-lignocellulosic materials may additionally be used, such as but not limited to, aluminum foil coated with a polymer, plastic sheets and many others.

A cutter 12 may be positioned near the end of mandrel 4 for cutting the circumference of the hollow tube in a radial direction in order to separate the tube into a plurality of individual pieces 14. The individual pieces 14 may then be transported via transportation machinery 15 (shown figuratively as rails) to a station for further processing.

FIG. 2 is a side view of the rolls 6, 8 and 10 in FIG. 1 and shows that an adhesive 20 is disposed between the respective, outer, middle, and inner layers so that they are bonded together when wrapped around mandrel 4. Adhesive 20 may be spread on the top, bottom, or both sides of the bonded layer. Adhesive 20 is bitumen based, that is, the active component of the adhesive may comprise bitumen or a mixture of bitumen. The active material may also comprise additives. The adhesive may also comprise fillers. “Active” refers to the substance that performs an adhesive and/or cohesive bond between the layers.

Bitumen (or bituminous materials, the terms being used interchangeably throughout), which includes without limitation, asphalt, pitch and coal tars, has been utilized in the past as a sealing material, such as roofing material, road paving material or impregnation material. However, bituminous materials have not heretofore been used for bonding layers of products like spiral-wound or convolute-wound tubes and/or corrugated board.

Asphalt and coal tar have a similar appearance but are derived from different raw materials and have different chemistry. Coal tar is typically obtained by heating bituminous coal to very high temperatures and collecting the volatile materials that are produced. These volatiles are referred to as crude coke oven tar, and the solid residue left behind is called coke. The crude coke oven tar is processed to recover a variety of materials including creosote and precursors for a large number of other important chemicals. The residue left after this processing step is called coal tar pitch, which comprises primarily aromatic hydrocarbons. The coal tar pitch is the material used in the more familiar applications of roofing and asphalt concrete surface treating.

Asphalt, on the other hand, is derived from fossilized fuel (petroleum or crude oil, the terms being used alternatively) and comprises primarily aliphatic hydrocarbons. Crude oil is processed at a refinery by distilling off the “light ends” to produce materials such as ethane, propane, gasoline, fuel oils, and chemical intermediates. The residue that remains from the distillation is referred to as straight-run asphalt, used primarily (usually after further processing, such as but not limited to, mixing, oxidation, or precipitation) for road paving applications, construction sealants and waterproofing materials.

The present invention is not limited to the particular type of bitumen. The bitumen may be of any type, such as but not limited to, VR (Vacuum Residue of low vacuum distillation), DVR (Deep Vacuum Residue), PA (Precipitated Asphalt), PPA (Propane Precipitated Asphalt), BB (Blown Bitumen), tar, pitch, or any mixture thereof. The bitumen-based adhesive 20 may have any suitable characteristics, such as but not limited to, penetration in accordance with ASTM D-5, e.g., between 5 to 500 mm/10, or 20 to 200 mm/10, or 50 to 150 mm/10.

The additives may comprise, without limitation, natural polymers, synthetic polymers, wax, starch, oil, solvents, surfactants, biocides, fungicides, fire retarder, etc. The synthetic polymers may comprise, without limitation, PE (Polyethylene, regular or linear, low, medium, or high density), PP (Polypropylene, regular or linear or atactic, low, medium, or high density, homo polymer or copolymer), PB (Polybutylene, regular or linear or iso, low, medium, or high density), SBS (Styrene Butadiene Styrene), SBR (Styrene Butadiene Rubber), BR (Butadiene Rubber), EVA (Ethylene Vinyl Acetate copolymer), PS (polystyrene) or acrylic resin. The adhesive may be in any form such as hot-melt, dissolved in an organic solvent, emulsified in water, suspended in water, etc.

The fillers may comprise, without limitation, natural or synthetic particulate (powdered) or fibrous material such as limestone, gypsum, kaolin, talc, mica, coal-ash, perlite, vermiculite, cotton, synthetic fibers, pulp, etc.

Reference is now made to FIG. 3, which illustrates a spiral-wound tube 30, constructed in accordance with an embodiment of the invention. Spiral-wound tube 30 may be constructed as shown in FIG. 1, wherein the layers are fed at an angle less than a right angle to the mandrel 4. One non-limiting example of spiral-wound tube 30 is the body of a cleanser can, made of spirally-wound chipboard, for example. Spiral-wound tube 30 may thus comprise layers 31, 32 and 33 bonded with adhesive 20.

The invention is not limited to spiral-wound tubes. Reference is now made to FIG. 4, which illustrates a convolute-wound tube 40, constructed in accordance with an embodiment of the invention. Convolute-wound tube 40 may be constructed similarly as shown in FIG. 1, except that the layers are fed generally perpendicularly to the mandrel 4 so that the layers are at least partially wound upon each other. Convolute-wound tube 40 may comprise layers 41, 42 and 43 bonded with adhesive 20. One non-limiting example of convolute-wound tube 40 is a spice can comprised of convolutedly wound manila, for example.

Convolute-wound tube 40 may comprise a long strip (or sheet and the like) of lignocellulosic material wrapped around itself, forming a tube of several layers. A short inner or outer layer (full or partial circumference) may be convoluted before or after the main strip.

Reference is now made to FIG. 5, which illustrates a corrugated board 50, constructed in accordance with an embodiment of the invention. Corrugated board 50 may comprise a corrugated sheet 51 bonded to one or more outer sheets 52. Corrugated sheet 51 is bonded to outer sheets 52 with bitumen-based adhesive 20. Outer sheet 52 may be smooth or non-smooth (such as but not limited to, wavy, corrugated, roughened, textured, etc.) Corrugated sheet 51 may comprise a minimum of two layers (outer layer and corrugated layer), but may comprise any number of layers. For example, corrugated board 50 may comprise one or more corrugated sheet 51 sandwiched between two or more sheets 52. The term “corrugated” encompasses any kind of corrugated, honeycomb, wavy, celled or finned structure, the terms being used interchangeably. At least one or all of the corrugated sheet 51 and outer sheets 52 may comprise a lignocellulosic material.

It is appreciated that various features of the invention which are, for clarity, described in the contexts of separate embodiments, may also be provided in combination in a single embodiment. Conversely, various features of the invention which are, for brevity, described in the context of a single embodiment, may also be provided separately or in any suitable subcombination.

1. A method comprising:
winding a first layer of a material about a mandrel; and
bonding a second layer of a material to said first layer with a bitumen-based adhesive, wherein an active component of said bitumen-based adhesive is bitumen, and wherein at least one of said first and second layers comprises a lignocellulosic material.

2. The method according to claim 1, wherein both said first and second layers comprise a lignocellulosic material.

3. The method according to claim 1, further comprising forming a spiral-wound tube by winding said first and second layers at an angle less than a right angle to said mandrel.

4. The method according to claim 1, further comprising forming a convolute-wound tube by winding said first and second layers generally perpendicularly to said mandrel.

5. The method according to claim 1, wherein said bitumen-based adhesive comprises at least one of an additive and a filler.

6. The method according to claim 1, wherein said bitumen comprises at least one of asphalt, coal tar, pitch, VR (Vacuum Residue of low vacuum distillation) bitumen, DVR (Deep Vacuum Residue) bitumen, PA (Precipitated Asphalt), and PPA (Propane Precipitated Asphalt), BB (Blown Bitumen).

7. The method according to claim 5, wherein said additive comprises at least one of a natural polymer, synthetic polymer, wax, oil, solvent, surfactant, biocide, fungicide, and fire retarder.

8. The method according to claim 7, wherein said synthetic polymer comprises at least one of polyethylene, polypropylene, polybutylene, SBS (Styrene Butadiene Styrene), BR (Butadiene Rubber), EVA (Ethylene Vinyl Acetate copolymer), PS (polystyrene) and acrylic resin.

9. The method according to claim 5, wherein said filler comprises at least one of limestone, gypsum, kaolin, talc, mica, coal-ash, cotton, natural fiber, pulp and synthetic fiber.

10. A method comprising:
forming a corrugated board by bonding a corrugated sheet to at least one outer sheet with a bitumen-based adhesive, wherein an active component of said bitumen-based adhesive is bitumen, and wherein at least one of said corrugated sheet and said outer sheet comprises a lignocellulosic material.

11. An article comprising:
a wound tube formed by winding a first layer of a material about a mandrel, and bonding a second layer of a material to said first layer with a bitumen-based adhesive, wherein an active component of said bitumen-based adhesive is bitumen, and wherein at least one of said first and second layers comprises a lignocellulosic material.

12. The article according to claim 11, wherein both said first and second layers comprise a lignocellulosic material.

13. The article according to claim 11, wherein said wound tube comprises a spiral-wound tube formed by winding said first and second layers at an angle less than a right angle to said mandrel.

14. The article according to claim 11, wherein said wound tube comprises a convolute-wound tube by winding said first and second layers generally perpendicularly to said mandrel.

15. The article according to claim 11, wherein said bitumen-based adhesive comprises at least one of an additive and a filler.

16. The article according to claim 11, wherein said bitumen comprises at least one of asphalt, coal tar, pitch, VR (Vacuum Residue of low vacuum distillation) bitumen, DVR (Deep Vacuum Residue) bitumen, PA (Precipitated Asphalt), PPA (Propane Precipitated Asphalt), BB (Blown Bitumen).

17. The article according to claim 15, wherein said additive comprises at least one of a natural polymer, synthetic polymer, wax, oil, solvent, surfactant, biocide, fungicide, and fire retarder.

18. The article according to claim 17, wherein said synthetic polymer comprises at least one of polyethylene, polypropylene, polybutylene, SBS (Styrene Butadiene Styrene), BR (Butadiene Rubber), EVA (Ethylene Vinyl Acetate copolymer), PS (polystyrene) and acrylic resin.

19. The article according to claim 15, wherein said filler comprises at least one of limestone, gypsum, kaolin, talc, mica, coal-ash, cotton, natural fiber, pulp and synthetic fiber.

20. An article comprising:
a corrugated board formed by bonding a corrugated sheet to at least one outer sheet with a bitumen-based adhesive, wherein an active component of said bitumen-based adhesive is bitumen, and wherein at least one of said corrugated sheet and said outer sheet comprises a lignocellulosic material.
